(19) United States
(12) Patent Application Publication
(10) Pub. No.: US 2009/0212215 A1
(43) Pub. Date: Aug. 27, 2009

(54) SCANNING ELECTRON MICROSCOPE AND METHOD OF MEASURING PATTERN DIMENSION USING THE SAME

(75) Inventors: Wataru Nagatomo, Yokohama (JP); Chie Shishido, Kawasaki (JP); Maki Tanaka, Mito (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi High-Technologies Corporation

(21) Appl. No.: 12/369,774

(22) Filed: Feb. 12, 2009

(30) Foreign Application Priority Data
Feb. 27, 2008 (JP) 2008-045400

(51) Int. Cl. G01N 23/00

(52) U.S. Cl. 250/311

(57) ABSTRACT

In dimension measurement of semiconductor pattern by CD-SEM, the error value between dimensional measurement value and actual dimension on the pattern is much variational as it is dependent on the cross-sectional shape of the pattern, and a low level of accuracy was one time a big problem. In the present invention, a plurality of patterns, each different in shape, were prepared beforehand with AFM measurement result and patterns of the same shape measured by CD-SEM. These measurement results and dimensional errors were homologized with each other and kept in a database. For actual measurement of dimensions, most like side wall shape, and corresponding CD-SEM measurement error result are called up, and the called-up error results are used to correct CD-SME results of measurement object patterns. In this manner, it becomes possible to correct or reduce dimensional error which is dependent on cross-sectional shape of the pattern.

### BACKGROUND OF THE INVENTION

1. Field of the Invention

This invention relates to a semiconductor inspection equipment to evaluate if the circuit pattern formed on a semiconductor substrate is good for processing or not, and in particular, relates to a scanning electron microscope having the capability of measuring dimensional values of the above circuit pattern and a method of measuring pattern sizes using the same microscope.

2. Description of the Related Art

In the semiconductor manufacturing process, the trend concerning the circuit pattern formed on the wafer is fast moving toward microfabrication, and so much so that the process monitoring to keep watch over if the pattern formation is proceeded with exactly as designed is all the more increasing importance. According to the IRS (International Technology Roadmap for Semiconductors), the well-known roadmap for semiconductors, the wiring dimension of the finest pattern of a transistor gate is envisaged to realize 18 nm or even finer. Evaluation of such a fine shape of pattern and high dimensional precision will become needed at the site of semiconductor manufacturing in the days ahead.

As an evaluation equipment for a very fine pattern on the wafer in the order of several tens nano meters, a Critical-Dimension Scanning Electron Microscope (CD-SEM) used for measurement of pattern sizes and having the capability of taking the pattern image of 100,000 to 300,000 magnifications has been in use conventionally. With a focusing lens the CD-SEM narrows down the beam of electrons emitted from the electron gun provided over the wafer and scans over the specimen two-dimensionally with a scanning coil. Secondary electrons generated from the surface of the specimen by the radiation of beam of electrons are captured by a secondary electron detector, and the signal thus obtained is recorded as image (called as SEM image, hereinafter). Amount of generated electrons is varied depending on concaves and convexes on the surface of the specimen. Therefore, by evaluating the secondary electron signal, it becomes possible to know shape variation if any exists on the surface of the specimen. In particular, availing of sudden surge of secondary electron signal seen at the edge portion of the pattern, the position of the edge in the SEM image of the semiconductor circuit pattern is reckoned and utilized for measurement of dimensions.

Japanese Unexamined Patent Application Publications (JP-A) No. 2006-093251 and JP-A-2006-038945 disclose a method of measuring dimensions as a means to resolve the question of measuring error dependent on the cross-sectional shape of the pattern, in which method a database comprising the cross-sectional shapes of the patterns prepared in advance and the corresponding waveforms of CD-SEM signals is used to presume the cross-sectional shape of the pattern from the waveforms of the CD-SEM signals available from the measurement object and to conduct dimensional measurement on the basis of the result of the aforesaid presumption.

In the conventional dimension measuring method, the position of the edge of the pattern of the measurement object was determined by making use of the peak positions and amounts of the signal waveforms or the changing situation of the waveforms. However, the above method had weak points in that the it was difficult to know exactly to which part of the cross-section the measured dimension corresponded (for example, whether the top portion of the pattern or the bottom portion). Another problem was that when the cross-sectional shape of the pattern changed, measuring errors could also occur depending on the shape. This problem is explained in FIG. 13. FIG. 13A shows an example where from the CD-SEM signal waveform 1303 of the pattern 1301 with an upright side wall, the edge position 1307 was calculated by means of the conventional threshold method. The foregoing threshold method decides on the edge position at the point of threshold value (50%, for example) between the maximum and minimum values of the signal amount in around the edge portion. In the present example, the difference 1309 between the actual edge position 1305 of the cross-section (denoted as the bottom position) and the calculated edge position 1307 was an error.

On the other hand, FIG. 13(b) shows an example where from the pattern 1302 with its side wall aslant, the edge position 1308 was calculated in a similar way, but the calculated edge position was different from the above error 1309. That is, the calculated result of the edge position, namely the error, was varied depending on the cross-sectional shape of the pattern. This variation in the measuring error is derived from the fact that the conventional measurement by the CD-SEM did not take into consideration the change of the CD-SEM signal waveform depending on the difference of the cross-sectional shape of the pattern. With the advancement of microfabrication in the semiconductor manufacturing process, such variation in measuring error has an unignorable effect, and therefore, it is necessary to resolve such error for the purpose of realizing high-precision dimensional measurement.

A measuring means to enable measurement of the cross-sectional shape of the pattern while staying unaffected by measuring errors depending on the cross-sectional shape as above is the atomic force microscope (AFM). The AFM is a device to measure the cross-sectional shape of a pattern by contact or non-contact scanning while keeping a certain atomic force between a probe and the surface of a specimen. The AFM is suitable for process monitoring, as it is a nondestructive measurement method. However, because the AFM measurement is dependent on probing or scanning of stage, its throughput is generally low in comparison with the CD-SEM. For this reason, there is difficulty in carrying out enough amount of measurement at the actual semiconductor manufacturing line so as to have a correct picture of all changes occurring in the process.

Both of the methods disclosed in the above JP-A-2006-093251 and JP-A-2006-038945 conduct measurement by using only the CD-SEM measurement method, leading to a problem in that the cross-sectional shape is hard to grasp precisely.

### SUMMARY OF THE INVENTION

The present invention relates to conducting high-precision dimensional measurement which is little affected by difference of cross-sectional shape of the pattern and has much less variation in measuring errors.

In other words, the present invention intends to carry out dimensional measurement by utilizing both the CD-SEM measurement and the AFM measurement in parallel with each other so as to resolve the problem in case of the measurement made by using only the CD-SEM method, namely the problem of measuring errors dependent on the cross-sectional shape of the pattern, and to realize higher throughput than in case of the measurement made by using only the AFM method.

The measuring method according to the present invention, it becomes possible to control the measuring errors dependent on the cross-sectional shape of the pattern to the same level as in the case of the AFM measurement and to realize several to several tens times as much throughput as in the case of the AFM measurement. To be concrete, a database is to be preliminarily built up covering the AFM measurement data for various pattern shapes along with dimensional measuring errors derived from the CD-SEM measurement (the errors being the differences between the CD-SEM measurement result and the AFM measurement result) for the same patterns as aforementioned, the latter being homologized with the former properly; for actual dimensional measurement, both the CD-SEM measurement and the AFM measurement are carried out for the patterns of the measuring object; out of the AFM measurement data stored in the database, the data (aa) which is most closely identical to the dimensional measuring result of the above AFM measurement is located; then, out of the dimensional measuring errors data of the CD-SEM measurement in the database, the data (bb) that corresponds with the above located data (aa) is selected; finally, based on the selected data (bb) of the dimensional measuring error of the CD-SEM measurement result, correction is made of the dimensional measurement result of the measurement object pattern for outputting.

With a view to achieving the above aims, the present invention is configured comprising: scanning electron microscope means to obtain secondary electron image of the pattern of a measurement object, CD-SEM signal waveform forming means to form CD-SEM signal waveforms of measurement object from the secondary electron image; dimension dispersion calculating means to calculate data dispersion of the evaluating pattern from CD-SEM signal waveforms; means for calculating number of measuring points necessary for fulfilling the desired dimension measuring accuracy based on dimension dispersion; GUI displaying means to display the number of measuring points for AFM; means for calculating dimensional measuring error from the AFM measurement result and the CD-SEM measurement result for the same pattern; means for storing database for the AFM measurement result along with the dimension measuring error of the CD-SEM measurement homologized with each other; means for selecting the AFM measurement data that is most closely identical to the AMF measurement result for the pattern of the measurement object, by referring the AMF measurement result to the AFM measurement database at the time of actual dimension measurement; means for calling up the CD-SEM dimension measuring errors corresponding to the selected AFM measurement data; means for correcting the CD-SEM dimension measurement result for the pattern of the measurement object based on the called-up CD-SEM dimension measuring errors; and means for outputting corrected dimension values.

According to the present invention, availability of the AFM measurement result in the CD-SEM pattern size measurement makes it possible to realize high-precision measurement with reduced measuring error dependent on the cross-sectional shape of the pattern.

Further, according to the present invention, it also becomes possible to carry out dimension measurement of inverse tapered shape pattern which was difficult to do measurement because the signal waveform of the CD-SEM could only look down from over the pattern and therefore could not permit observation to discern difference of the patterns.

By using a database which was built up in advance, it becomes possible to reduce the number of AFM measurement points at the time of actual measurement and to gain higher throughput of measurement as compared with the case in which only the AFM is used for measurement.

These and other objects, features and advantages of the invention will be apparent from the following more particular description of preferred embodiments of the invention, as illustrated in the accompanying drawings.

### BRIEF DESCRIPTION OF THE DRAWINGS

FIG. 1 is a block diagram showing the basic processing flow relating to an embodiment of the present invention.

FIG. 2A is a block diagram of the SEM equipment relating to an embodiment of the present invention. FIG. 2B is a drawing diagrammatically illustrating the state where electrons are emitted from a semiconductor wafer by scanning of electron beam. FIG. 2C is a drawing showing that an amount of signal is obtained by detecting electrons emitted from a semiconductor wafer and is converted into images.

FIG. 3A is a drawing showing the cross-sectional shape of the pattern of the measurement object in contrast to the corresponding waveform of the CD-SEM signal. FIG. 3B is an explanatory drawing to explain how to detect the maximum slope position of the CD-SEM signal waveform as located in the side wall part. FIG. 3C is a drawing to explain with respect to the CD-SEM signal waveform on how to detect the position in the side wall part by a prescribed threshold value.

FIG. 4 is a drawing illustrating how to calculate data dispersion in dimension of a pattern from a CD-SEM image.

FIG. 5 is a drawing showing the relationship between the estimated dimensional error due to the data dispersion in dimension of a pattern and the number of the cross-sectional measurement points.

FIG. 6A is a drawing showing the data of the cross-sectional shape of the pattern obtained from the AFM measurement in relation to the method of preparing the AFM measurement data and the data of the corresponding dimensional measuring errors of the CD-SEM signal waveform. FIG. 6B is a drawing showing the CD-SEM signal waveform homologized with the data of the cross-sectional shape of the pattern obtained from the AFM measurement shown in the above FIG. 6A. FIG. 6C is a drawing showing the cross-sectional shape of the measurement object pattern homologized with the signal waveform of the CD-SEM signal waveform.

FIG. 7 is a drawing showing an example of database inquiry.

FIG. 8 is a drawing showing an example of the processing flow for correction of dimensional measuring error between the CD-SME measurement and the AFM measurement.

FIG. 9 is a drawing showing an example of GUI displaying the result of the dimensional measuring error correction between the CD-SME measurement and the AFM measurement.

FIG. 10 is a drawing showing an example of GUI display at the time of database compilation.

FIG. 11 is a drawing showing an example of configuration of network of various devices.

FIG. 12 is a drawing showing an example of processing flow based on the number of AFM measuring points for computing presumed errors of dimensional values due to declination of sampling positions for corresponding data.

FIG. 13A is a drawing showing an example of computing the edge position by the conventional threshold method from the CD-SEM signal waveform that has a pattern with an upright side wall. FIG. 13B is a drawing showing an example of computing the edge position by the conventional threshold method from the CD-SEM signal waveform that has a pattern with an aslant side wall.

### DESCRIPTION OF THE PREFERRED EMBODIMENTS

Hereafter, explanation is made of the preferred embodiments based on the drawings. Additionally, in the drawings to explain about the preferred embodiments, the members having the same function are marked with the same numerals, with repetition of explanation being omitted.

[Processing Flow of Dimension Measurement of Combination of CD-SEM and AFM]

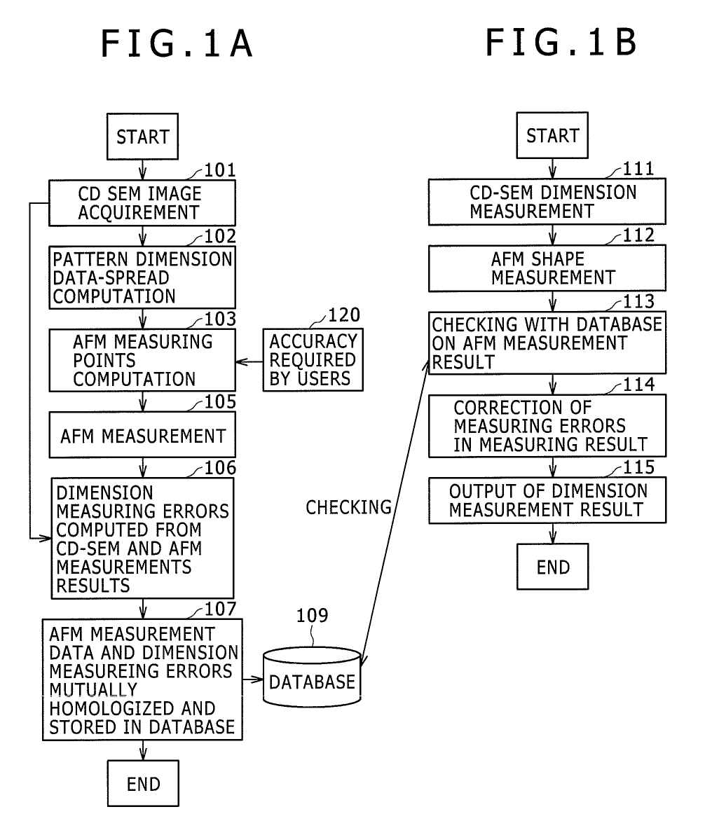

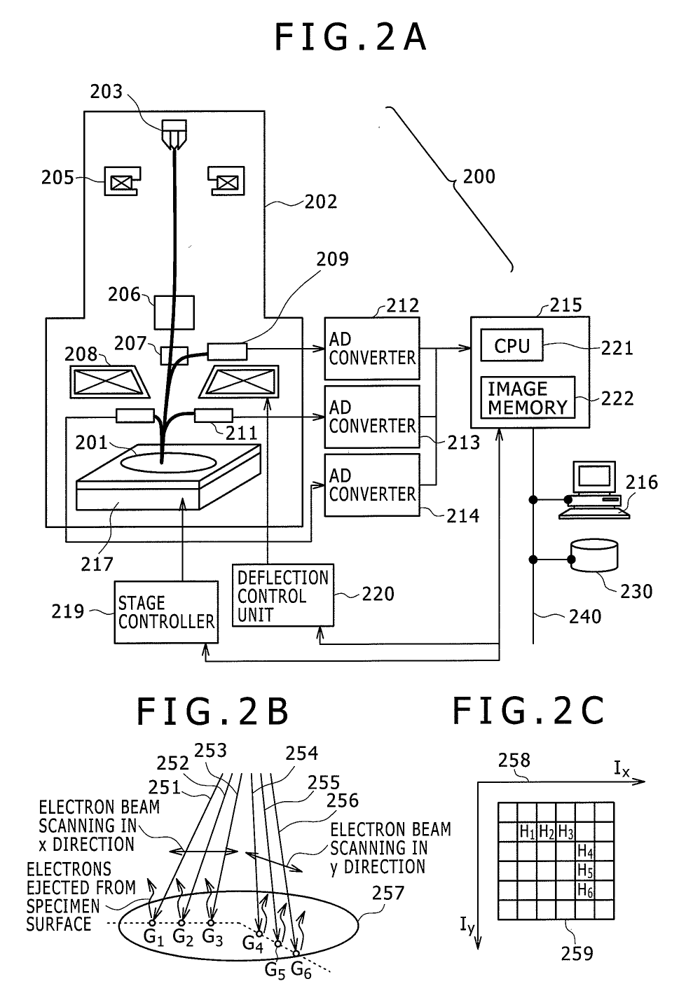

FIG. 1 shows the processing procedure of the dimension measuring means of the pattern by the CD-SEM (the block diagram is shown in FIG. 2) according to the preferred embodiment of the present invention. In the present invention, the evaluated result concerning the relations between the cross-sectional shapes obtained by the AFM measurement in patterns of various shapes and the CD-SEM signal waveforms is to be preliminarily recorded in the database. The actual measurement is conducted by using the above database, making it possible to correct any errors of the CD-SEM measurement occurring dependently on the cross-sectional shapes and realize high-precision measurement. In the database 109, there are to be stored the AFM shape measurement result of a plurality of patterns, each different in cross-sectional shape (to be referred to as “shape variation samples,” hereafter) and the dimension measuring errors (the difference of dimension measurement between the CD-SEM measurement and the AFM measurement) when the same patterns are subjected to the CD-SEM measurement). Since the data in the above database are to be used for correction of the dimension measuring errors between the CD-ESM measurement and the AFM measurement at the time of dimension measurement, it is desirable that the data should preferably include variations of cross-sectional shapes that might occur due to changes of measurement object processes.

In FIG. 1A shows the procedural steps for making the database, while in FIG. 1B shows the procedural steps for actual dimension measurement of measurement patterns. At first, explanation is given concerning FIG. 1A. Generally speaking, the dimension of the patterns has data dispersion in the longer direction, and it is difficult to keep the measuring points exactly of one accord between the CD-SEM measurement and the AFM measurement. Even if it is targeted for the two measurement methods to measure exactly the same shape of pattern, actually the measurement cannot get off the effect of LWR (=Line Width Roughness), and in most cases, the dimension under measurement is varied. In view of the foregoing, the dimension measuring method adopted in the present invention takes an approach taking it into consideration that there is some difference reasonably equivalent to LWR between both the measurement results of the CD-SEM measurement and the AFM measurement and both the samples prepared with an intention to form the same dimensions.

To start with, the CD-SEM image is acquired (101), and from the acquired CD-SEM image, the LWR of the pattern is computed (102). Then, in consideration of the LWR, a statistical methodology (more details are to be explained in reference to FIG. 5) is to be used to compute the number of the AFM measuring points conceived sufficient to comply with the level of dimension measurement accuracy as required by the users.

The above accuracy required by the users means the dimension measuring error between both the measurements, the error being attributable, precisely speaking, to the fact that the sets of measurement data of the same pattern (the CD-SEM signal waveform and the AFM shape measurement result) stored as the database 109 in the database server 230 is, as mentioned above, are not of one accord due to declination of sampling positions. By conducting the AFM measurement (105) matching with the number of computed AFM measuring points, the cross-sectional shape measurement data of the object pattern are to be acquired. Then, from the acquired CD-SEM measurement result and the AFM measurement result, the dimension measurement errors between both the measurements are to be computed (106). The computed dimension measurement errors and the cross-sectional shape measurement data obtained from the AFM measurement are homologized with each other and stored (107) in the database server 230.

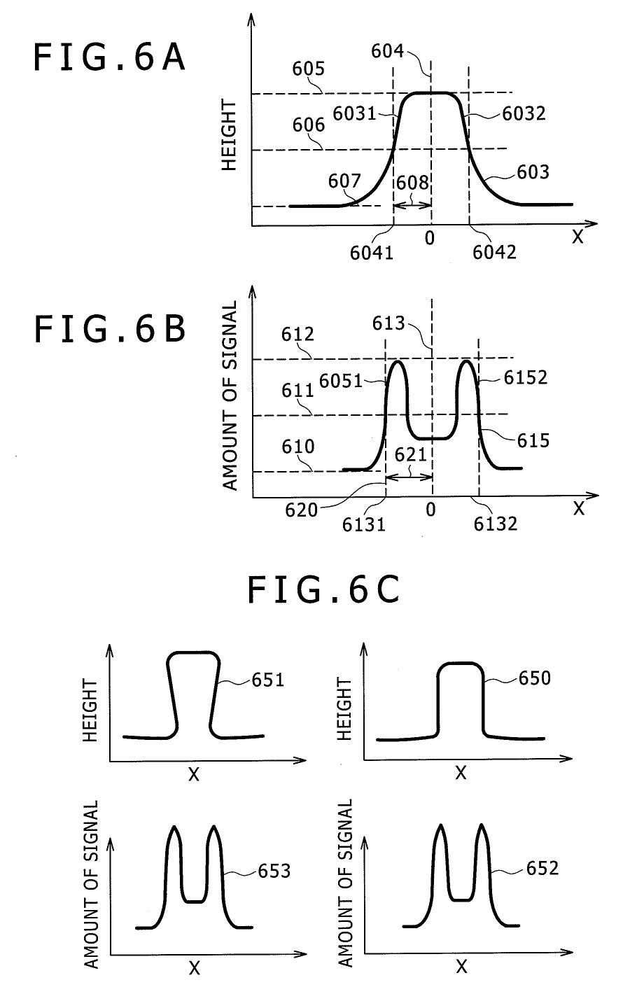

The above processing is carried out with each shape variation sample, and by homologizing the AFM measurement data for each pattern shape with the dimension measuring error data from the CD-SEM measurement for each same pattern, the data are compiled with consideration paid to the dispersion of pattern sizes into the database 109, which is saved in the database server 230 (the homologizing method is explained in detail in reference to FIG. 6).

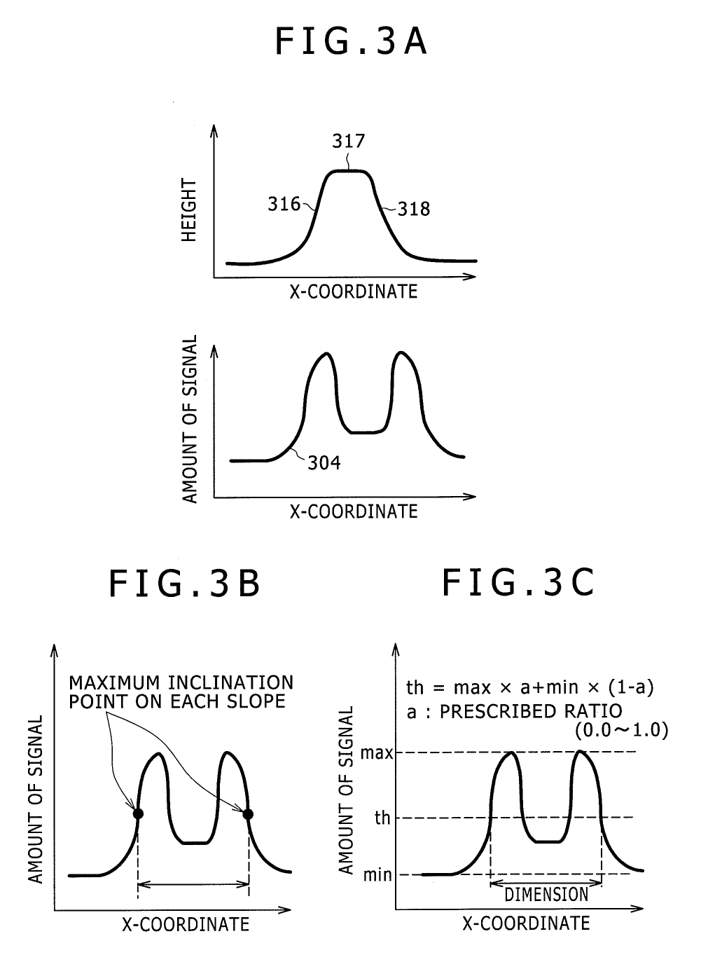

Next, explanation concerns FIG. 1B. The measurement object pattern is taken into image by the CD-SEM so as to acquire the CD-SEM signal waveform of the measurement object pattern, and from the acquired signal waveform, the dimensional values of the pattern are to be measured in the manner as explained in FIG. 3 (111). Then, the AFM measurement is made of the measurement object pattern (112) so as to acquire the AFM measurement data for inquiry to the database 109. The AFM measurement in this instance is intended to acquire the data on the cross-sectional shape including the data of the side wall shape and the height of the measurement object pattern and, therefore, can do with a limited number of measuring points but does not require such a large amount of measurement as was required for compiling the database 109 when it was needed to satisfy the users' requiring accuracy in consideration of LWR. As regards the number of measuring points, it is desirable to adopt a plurality of points within the region covered by the image taken in the CD-SEM measurement so that data dispersion (not LWR) respecting the shape of the side wall in the pattern of the measurement object may be reduced.

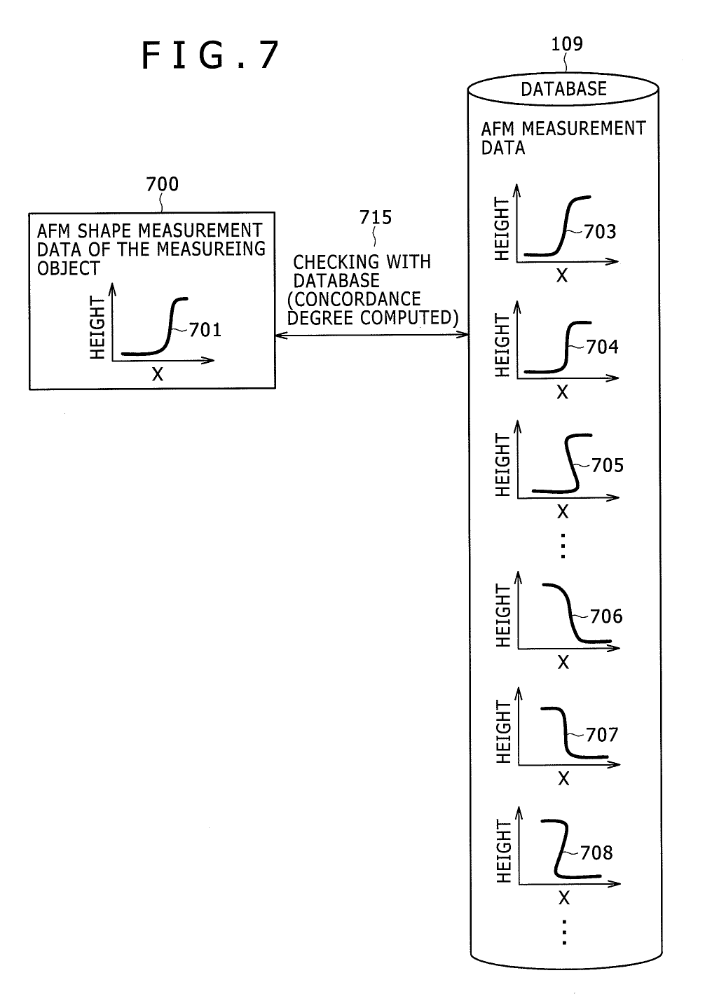

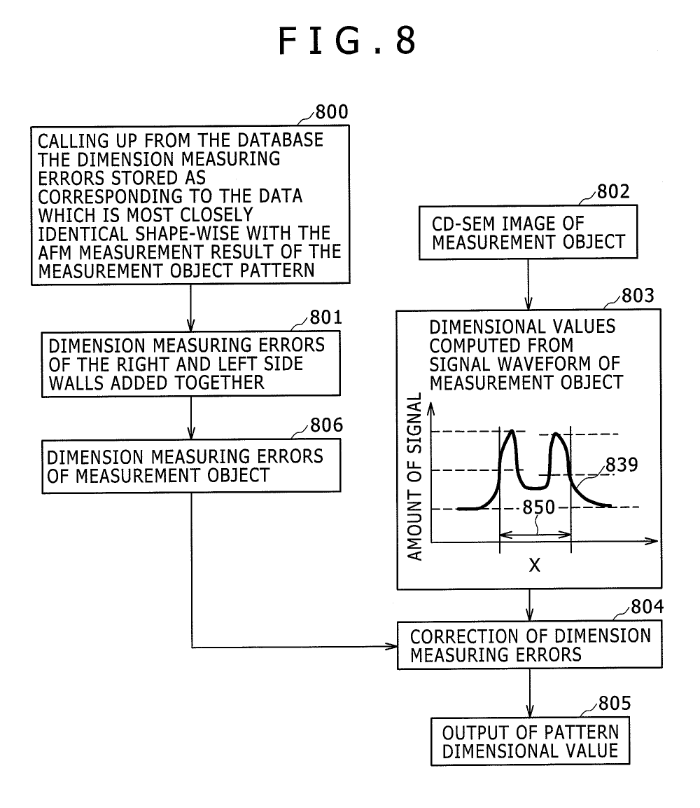

The acquired AFM measurement data is checked with the database 109 stored in the database server 230 (113), and the dimension measurement errors corresponding to the AFM measurement data which is most closely identical to the AFM measurement data of the measurement object is called up (more details about the inquiry processing are explained in reference to FIG. 7). Based on the dimension measurement errors thus called up, correction processing is to be conducted of the dimension measurement result of the pattern of the CD-SEM (114) (correction processing is explained in more detail in reference to FIG. 8). Lastly, the dimensional values corrected as above are to be outputted (115).

By carrying out the above processing, it becomes possible to attain high-precision measurement with necessary correction done in respect of the dimension measurement errors between the CD-SEM measurement result and the AFM measurement result. Also, the use of the database 109 compiled in consideration of LWR of the pattern so as to satisfy the users' request for the dimension measurement accuracy allows the AFM measurement to do the job with a limited few measuring points, satisfying the dimension measurement accuracy as required by the users. The measurement by using the database 109 can do with fewer number of measuring points than the measurement without the database 109. Likewise, the measurement can be performed at a higher throughput.

[Setup of Length Measurement SEM]

FIG. 2 is a diagram of a scanning electron microscope (which may be referred to as “SEM” hereafter) for semiconductor pattern measurement according to the present invention. FIG. 2A is a block diagram of the scanning electron microscope 200 which is to acquire the secondary electron image (SE image) of a specimen, showing the outline of the equipment formation. Denoted by 203 is an electron gun to generate electron beams 204, which are irradiated to focus at any point on the semiconductor wafer 201, a specimen placed on the stage 217, by control of the deflector 206 and the objective lens 208. From the semiconductor wafer 201 irradiated by the electron beams as above, the secondary electrons are emitted, and detected by the secondary electron detector 209. The detected secondary electrons are converted to digital signals by the A/D converter 212, stored in the image memory 222, and processed properly to desired purposes by the CPU 221.

Denoted by 215 is the processing and controlling unit composed of computer systems to give out control signals to the stage controller 219 to control the position of the stage 217 and to the deflection control unit 220 to control scanning performance of the electron beams 204 irradiated onto the semiconductor wafer 201, and also to conduct processing or control, such as various image processing of measurement images. Operation for the foregoing processing and controlling is carried out by the CPU 221. Also, the processing and controlling unit 215 is connected to the display 216, which is provided as a graphical user interface (GUI) to display images, etc., for the users. Denoted by 217 is the XY-stage which enables movement of the semiconductor wafer 201 and image-taking of the aforesaid semiconductor wafer in any desired position. Further, the processing and controlling works in the processing and controlling unit 215 may be allocated partly or wholly to a plurality of different processing terminals accordingly.

FIG. 2B illustrates the method of imaging the amount of signals of the electrons emitted from the semiconductor wafer when the electron beams are irradiated and used for scanning on the wafer. The electron beams are, as shown in FIG. 2B, are irradiated scanning in X direction from 251 to 253 and in Y direction from 254 to 256. It is possible to change the scanning direction by changing the deflecting direction of the electron beams. The points on the semiconductor wafer on which the beams 251-253 scanned in the X-direction are marked G1 to G3. Likewise, the points on the semiconductor wafer on which the beams 254-256 scanned in the Y-direction are marked G4 to G6. The amount of signal of the electrons emitted at the above points G1 to G6 turn out to be luminosity values for the picture elements H1 to H6 of the image 259 shown in FIG. 2C. (The suffixes in the lower right side of G and H designations are obverse to each other.) Denoted as 258 is the coordinate system indicating x and y directions within the image.

Hereinbelow, explanation is made in detail of the processing flow at the time of database compilation shown in FIG. 1A and of the processing flow at the time of dimension measurement shown in FIG. 1B.

[Computation of Line Breadth Dimension Value from CD-SEM Signal Waveform (Steps 101 and 102)]

FIG. 3 is a drawing to explain a general method of computing the dimensional value equivalent to the line breadth of the pattern from the CD-SEM image of the pattern of the measurement object pattern. In FIG. 3A, the upper graph and the lower graph are intended to show the relationship between the cross-sectional shape 316 of the measurement object pattern and the CD-SEM signal waveform 304. The CD-SEM signal waveform 304 expresses signal strength of the secondary electrons obtainable by the SEM. Generally, the signal strength of the secondary electrons becomes stronger as the angle of inclination of the side wall of the measurement object grows nearer to parallel with the incident angle of the incident electrons, and therefore, the signal strength in the side wall portion 318 is greater than the signal strength in the flat portion 317. As explained above, the strength of the secondary electron is greater, for example, in the side wall portion of the line pattern. By executing the processing explained in the following in regard to the above signal waveform, it becomes possible to compute a dimensional value equivalent to the line width of the pattern.

FIGS. 3B and 3C are the drawings explaining about examples of the conventional method in which the position of the side wall portion of the pattern is detected so as to compute the dimensional values of the pattern from the CD-SEM signal waveform. The example according to FIG. 3B represents the method by which the maximum slope position of the CD-SEM signal waveform is detected as the position of the side wall position. That is, differential processing is made of the signal waveform to find the position where the differential curve is at maximum; that maximum position is to be regarded as the maximum slope position of the side wall. The example according to FIG. 3C is the method by which the position of the side wall portion is detected by a prescribed threshold value. That is, a threshold value is decided based on the maximum and minimum values of the signal waveform and by using the formula described in FIG. 3C; by threshold processing, the position of the side wall portion is to be computed. In the abovementioned manner, the positions of the right and left side wall portions are computed, and the distance between the right and left side walls are to be regarded as the dimensional value of the pattern.

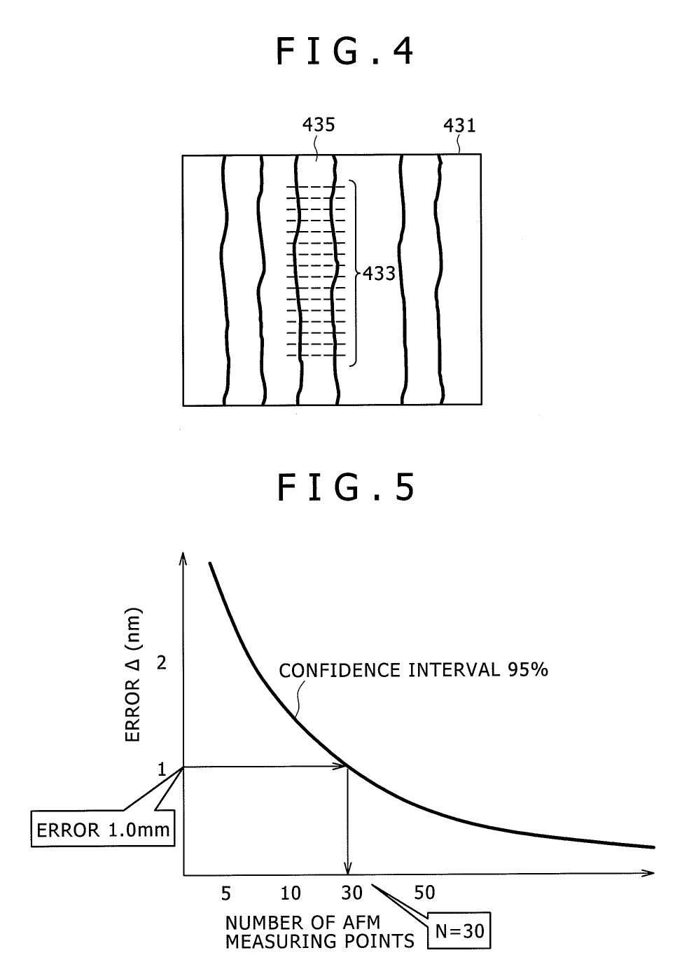

In contrast to the foregoing, the present invention is to determine the number of measuring points of the AFM measurement data stored in the database 109 of the database server 230 on the basis of the dispersion of the dimensions of the patterns for which the CD-SEM measurement was conducted. FIG. 4 is an example of the CD-SEM image 431 of the line pattern 435. This CD-SEM image is a multiple image created by placing multiple frames (for example, 5-30 frames) of SEM image which were obtained after scanning and image-taking of the region on the semiconductor wafer including the object pattern multiple times on the CD-SEM equipment. As an example of computing dimension dispersion of the pattern after CD-SEM measurement, there is such a method that the dimensional values of the above pattern are measured in multiple points along the length-wise direction of the pattern (multiple points along multiple dotted lines denoted as 433 in FIG. 4) and the standard deviation of such dimensional values is taken as the dispersion of the pattern sizes measured by CD-SEM. As to the size of the region to be measured in longer direction, it is desirable to do measurement for a length long enough to be able to grasp dispersion of dimensions of the pattern.

[Computation of Number of Points for AFM measurement (Step 103)]

Explanation is made as to how to set up the number of AFM measurement points, when the measurement is intended for preparation of the database. When compiling the database 109 comprising the CD-SME measurement values and the AFM measurement values homologized with each other, this method enables computation of the number of the AFM measurement points necessary to satisfy the accuracy level, namely the errors between both of the measurement values as required by the users (viz., the errors between the two measurement values fall within the accuracy the user requires). In the present embodiment, it is assumed that the CD-SEM measurement points fully cover the entire range of AFM measurement. That is, the areas to be subjected to the AFM measurement are included in the region of the images of the measurement object patterns acquired for the sake of CD-SEM measurement.

The errors which are derived from disagreement of measuring points between different measuring devices (like CD-SEM and AFM) can be conceived as a problem of how to estimate the AFM measurement result, an equivalent to the average dimension of the parent population, with limited samples, where all the CD-SEM measurement points are assumed to be the parent population.

When AFM measurement points are n points, dispersion of measurement data of the parent population which is measured by CD-SEM is σ, and average value (true value) in cross-sectional measurement is u′, the range that the average value Xₘₑₐₙ for the samples of n AFM measurement points can take is expressed by (Formula 1).

μ′−t_{—}α/2*σ/sqrt(n)<Xmean<μ′+t_{—}α/2*σ/sqrt(n) (Formula 1)

The value “t_{—}α/2*σ/sqrt(n)” is the value of t([n−1] degrees of freedom) at which outside probability is “(α/2) %” of t distribution, and the maximum value of the estimated error of the average value (true value) in cross-sectional measurement μ′ become “t_{—}α/2*α/sqrt(n)”. As for α, generally 5% is often used (1−α=95% confidence interval). This value of “±t_{—}α/2*σ/sqrt(n)” is equivalent to the error between the average value of the parent population and the average value in case “n” pieces of samples are picked up from the parent population in a random manner among the measurement datasets of the pattern which are formed as to take certain same dimensions and shapes.

If dispersion (σ) of the parent population and the number of sampling data (n) are given, it is possible to estimate the error value. Reversely, if allowance for the error is given, it becomes possible to compute necessary number of sampling data (n) to satisfy the allowance for the error. FIG. 5 shows an example to explain how to compute the number of sampling, and for the purpose of securing a confidence interval of 95% the error value of below 1.0 nm, it is clear from FIG. 5 that 30 or more cross-sectional measurement points are required. As the above example indicates, the number of AFM measurement points necessary to satisfy the accuracy required by users can be obtained by evaluating the dimensional dispersion (σ) of the measurement object pattern available from the CD-SEM measurement value.

[Computation of Side Wall Shape Data and CD-SEM Signal Waveform (Steps 105, 106 and 107)]

FIG. 6 is a drawing to explain an example of the method of forming the data in which the AFM measurement data and the dimension measuring error (the difference in dimension measurement result between the AFM measurement and the CD-SEM measurement) of the CD-SEM signal waveform are homologized with each other. It is assumed that AFM measurement and CD-SEM signal waveform use the same magnification in x-direction. An example of generally practiced method for using the same magnification is to do calibration using the same pitch of the same pattern. The measuring points by CD-SEM must cover all of the AFM measuring points. (Step 105)

According to the present method, the AFM measurement data and the dimension measuring errors of CD-SEM signal waveform which are to be stored in the database 109 of the database server 230 should be stored with the data for the right side wall and the data for left side wall separately.

It has been already explained in the foregoing that the difference in dimension measurement value between CD-SEM measurement and AFM measurement varies depending on the cross-sectional shape of the pattern. Further, the variation mainly derives from variations in shape of the side wall portion of the pattern; and even if the pattern has a different distance between the right and left side walls, but if the shape of the side wall portion of the pattern is about the same, the difference of the dimension measurement value between both the measurements (the CD-SEM measurement and the AFM measurement) also shows about the same value; availing of this fact and in view of all other foregoing matters, the merit of storing data with treating the right side wall and the left side wall separately lies in that any pattern for which measurement has not been made for compiling the database 109 can still have its CD-SEM measurement value to be corrected, only if the data identical to the shape of the side wall portion is stored in the database 109 of the database server 230.

By using FIG. 6A, explanation is made below about the processing applied to the cross-sectional shape data 603 of the pattern acquired from the AFM measurement. The shape data 603 is first divided to the right and left side wall shape data. In respect of the cross-sectional shape data 603, positioned at a certain height (for example, a pattern height 606 designated by a certain percentage (e.g., 50%) in between the maximum value 605 and the minimum value 607) are the right and left side walls, the X-coordinates of which are to be computed (6041 and 6042 in the case of the example in FIG. 6A). Then, the average of the computed X-coordinates is designated to be the center coordinate 604 (the center coordinate 604 is set up as the original point (x=0)). The left side of the pattern center point (x=0) is called the left side wall shape 6031, and the right side is called the right side wall shape 6032. Now, for the purpose of compiling the database 109, the average side wall shape data are to be produced from the AFM data measured along the plurality of points in the longer direction of the line pattern. An average side wall shape can be computed by respectively computing firstly the aforesaid right and left side wall shapes 6031 and 6032 from each AFM measurement data and secondly an average value of X-coordinates corresponding to each height of the pattern in each side wall shape data.

By using FIG. 6B, explanation is made below about the processing applied to the CD-SEM signal waveform 615 acquired by the CD-SEM. The foregoing data is first divided into the signal waveform data corresponding to the right and left side wall measurement data. In respect of the signal waveform data 615, the X-coordinates 6131 and 6132 located on the right and left side of a signal amount equivalent to a certain signal amount (for example, a signal amount 611 designated by a certain percentage (e.g., 50%) in between the maximum value 612 and the minimum value 610) are to be computed. Then, the average of the two computed X-coordinates is designated to be the center coordinate 613 (the center coordinate 613 is set up as the original point (x=0 )). The left side of the pattern center point (x=0 ) is called the CD-SEM signal waveform 6151 of the left side wall, and the right side of the pattern center point (x=0 ) is called the CD-SEM signal waveform 6152 of the right side wall. Now, the average waveform data is to be produced from the CD-SEM signal waveform measured along a plurality of points. An average waveform data can be computed by computing firstly the waveforms corresponding to the left side wall and the right side wall from each CD-SEM signal waveform and secondly an average value of signal amount at X-coordinates in regard to each signal waveform.

In the above-mentioned manner, the AFM measurement data and the CD-SEM measurement result can be computed to be in separate forms of AFM measurement data and CD-SEM signal waveform respectively corresponding to the right and left side walls.

Subsequently, from the computed AFM shape measurement data and the CD-SEM signal waveforms for the right and left side walls, the dimension measuring errors of the CD-SEM measurement are computed separately for the right side wall and for the left side wall. Explanation here is made about the computation method only for the left side wall, but similar method of computation is as well applicable to the right side wall.

In the first place, by using the AFM measurement data of the left side wall shape 6031, the distance 608 from the pattern center coordinate 604 (x=0 ) to the position of the side wall where to determine the pattern size, is to be computed. The above position of the side wall where to determine the pattern size is the X-coordinate 6041 in the AFM measurement data of the left side wall which turns out to be a certain height 606 (this height 606 is located between the maximum value 605 of the pattern height and the minimum value 607 and at where to be designated by a percentage (e.g., 50%) or by a value of height (nm)). This distance 608 may be taken as the AFM dimension measurement result for the portion from the left side wall position to the pattern center.

In the next place, to be computed by using the CD-SEM signal waveform corresponding to the shape of the left side wall, is the distance 621 of the signal waveform equivalent to the portion from the side wall position where to work out the pattern size of the left side wall to the pattern center coordinate 604 corresponding AFM measurement data. Firstly, by imaging processing as explained in relation to FIG. 3, to be computed by using the CD-SEM signal waveform 6151 is the X-coordinate 6131 of the signal waveform section equivalent to the position where to work out the pattern size. Secondly, computed is the distance 621 between the aforesaid X-coordinate 6131 and the pattern center coordinate 613 (x=0 ). This distance 621 may be taken as the CD-SEM measurement result from the left side wall position where to work out the pattern sizes to the pattern center.

If the difference between the AFM dimension measurement result 608 on the side of the aforesaid left side wall and the CD-SEM measurement result 621 on the side of the aforesaid left side wall is found out, it becomes possible to compute the difference in dimension measuring error between the CD-SEM measurement and the AFM measurement on the side of left side wall. (Step 106)

The AFM measurement data computed respectively on the right and left side walls in the above manner and the dimension measurement errors deriving from the CD-SEM measurement of the right and left side walls of the same patterns are homologized with each other, and stored in the database 109 of the data server 230 (Step 107). By using this database 109 in connection with the inquiry to the database (Step 113) explained in FIG. 1, it becomes possible to call up the dimension measurement errors of the CD-SEM signal waveforms homologized with the AFM measurement data of the measurement object pattern obtained from the shape measurement by the AFM at the step of the AFM shape measurement (Step 112).

The above database 109 is able to store the data of not only the side wall of forward tapered shape or upright shape but also the pattern of reverse tapered shape.

In case the side wall of the measurement object pattern is in the reverse tapered shape 651 as shown in FIG. 6C, there is a problem in that the dimension measurement of the pattern may not be made correctly, because the dimension measurement, if made by the CD-SEM only, uses observation images only looking down from above in which little difference is observed in signal waveform if the pattern is of reverse tapered side wall having different angles of inclination or of upright side wall. For example, between the side wall having an upright pattern 650 and the side wall having a pattern of reversed taper 651, there is little difference between the corresponding CD-SEM signal waveforms 652 and 653. According to the measuring method of the present invention, however, the AFM measurement is also carried out in parallel with the CD-SEM measurement, making it possible to do measurement (more detailed explanation to come afterward in relation to FIG. 8), and correction of any dimension measurement errors, of the side wall of reverse tapered pattern in the same way as to treat a side wall of forward tapered shape. Dimension measurement of patterns of reverse tapered shape is now enabled by including patterns of reverse tapered shape in the shape variations of the database.

In the next place, explanation is made concerning the flow of processing at the time of dimension measurement. [Database Inquiry on Side Wall Shape Measurement Result (Steps 111, 112 and 113)]

The processing at the time of dimension measurement is first to take image of the measurement object pattern by using the CD-SEM shown in FIG. 2A and then to do dimension measurement according to the processing procedures indicated in FIG. 3 and FIG. 6B. (Step 111)

In the next place, measurement is made by the AFM of the shape of the measurement object pattern, and dimension measurement is conducted according to the processing procedures explained in reference to FIG. 6A. (step 112)

Now, explanation is made about the processing of checking the result of measurement by the AFM with the accumulated data stored in the database 109. (Step 113)

FIG. 7 is a drawing relating to the preferred embodiment of the present invention and explaining about one example of the method for checking the measuring result of the side wall shape of the measurement object pattern with the database 109 at the time of dimension measurement. In FIG. 7, the AFM shape measurement data 700 of the measuring object shows an example of the left side wall shape measurement data 701 of the measuring object. The side wall shape data 701 is to be checked with the AFM measurement data stored in the database 109 (715), and the side wall shape measurement data having the most identical shape (the data 703 is considered to be the most identical among the examples in FIG. 7) is called up from the database 109. In response to this side wall shape data 703 thus called up, the dimension measurement error (not shown in the drawing) of the CD-SEM signal waveform that was homologized with the side wall shape data 703 and stored in the database 109, is called up from the database 109. As mentioned in relation to FIG. 1, the dimension measurement error of the CD-SEM signal waveform thus called up by the checking (715) is used for correction of any difference in dimension measurement value between the CD-SEM measurement and the AFM measurement. Like manner is applied to the checking of the right side wall shape data.

As to the method of the above checking (715), for example, the error values of the two side wall shape data (the AFM shape measurement data of the measurement object pattern and the AFM measurement data stored in the database 109) are first obtained; and the square of the above error values (the square of difference between the two side wall shape data values in the pattern height direction <namely, the value of the axis in the height direction in FIG. 7> added over the entirety <in the direction of X-axis> of the two kinds of side wall shape data) can be used. In this case, the smallest squared error is considered to be indicative of the two side wall shapes that are most closely identical to each other.

The method of checking (715) is not limited to the method described above but any other method will do if it can call up a side wall shape data the closest in shape to the side wall shape data of the measurement object from among the side wall shape data 703 to 708.

In the above manner, it becomes possible to call up the side wall shape data showing high degree of concordance in pattern shape with the right and left side wall shape data of the measurement object pattern, and the corresponding dimension measurement error, respectively from the database 109.

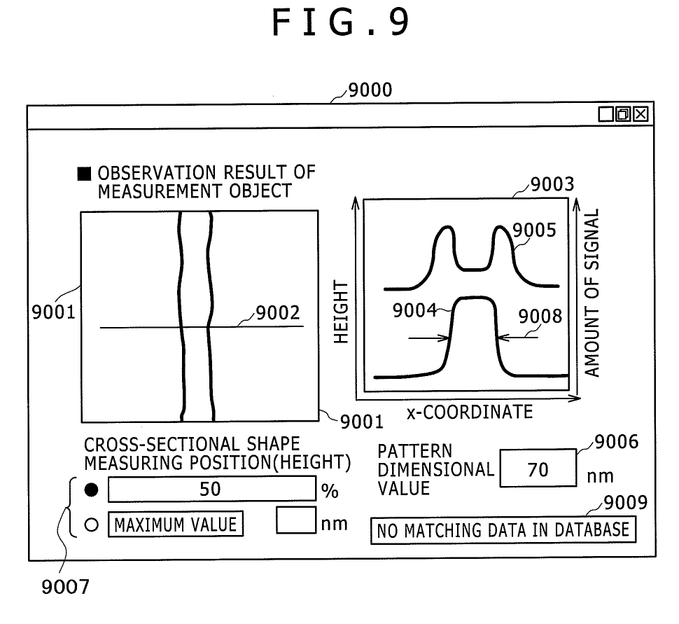

In checking the side wall shape of the measurement object pattern with the database 109, if there is no matching side wall shape data (in case the smallest squared error is larger than a prescribed value), it is also possible to notify the user that there is no checkable data (for example, the sign 9009 is displayed by GUI as explained in relation to FIG. 9. The above judgment that no checking data is available may be exercised in the following way. For example, if square error for two side wall shape data is used at the time of checking, a certain threshold is to be set against the square error, and judgment is to be made as no checking data over a threshold. When no checking data was announced, the user is free to treat the particular measurement object as trial and conduct database compilation or supplementation of data as explained in connection with FIG. 1A

[Correction of Dimension Measuring Errors between CD-SEM Measurement and AFM Measurement (Step 114)]

FIG. 8 is a drawing explaining the method of computing values for correction of the dimension measuring errors of dimension measurement result by CD-SEM measurement of the measurement object pattern, standing for Step 114 at the time of the processing flow of dimension measurement according to FIG. 1B and relating to the preferred embodiment of the present invention.

By the checking process (715) in above FIG. 7, the dimension measuring errors of the CD-SEM signal waveform stored in the database 109 homologized with the AFM side wall shape data in the database which is most closely identical shape-wise with the AFM measurement result of the side wall shape of the measurement object pattern, is called up from the database 109 (800); and with the result that has thus been obtained, the dimension measuring errors of the right and left side walls are added together (801); as the result of the above addition, the dimension measuring errors of the CD-SEM measurement result of the measurement object.

Next, an image of the measurement object pattern is taken by the CD-SEM; from the CD-SEM image 802, the CD-SEM signal waveform 839 is computed (803); and from this signal waveform 839 and through prescribed image processing, the pattern dimensional value 850 is computed (the computing method is the same as FIG. 3). From the aforesaid pattern dimensional value 850, the above dimension measuring errors are deducted so as to make correction of the dimension measuring errors (804); thus, the pattern dimensional value with the dimension measuring errors corrected is outputted (805).

As above, by using the CD-SEM signal waveform and the AFM measurement data, it has now become possible to output the dimensional values (805) after correction is made about the dimension measuring errors of the CD-SEM measurement result of the measurement object pattern.

[Measurement Result Display GUI (Step 115)]

FIG. 9 is a drawing relating to a preferred embodiment of the present invention and showing an example of GUI wherein at the time of dimension measurement, the dimensional measuring errors of the measurement object is outputted after correction.

The CD-SME measurement data display area 9001 can also overlay the display of the AFM measurement point 9002.Also in the pattern shape data display area 9003, it is possible to display the CD-SEM signal waveform 9005 together with the AFM shape measurement result 9004. In this instance, position selection is to be made so that position is determined corresponding to the pattern centers of the AFM measurement data and the CD-SEM signal waveform; it is also possible to make the CD-SEM signal waveform 9005 and the AFM shape measurement result 9004 concentric

While this GUI performs dimension measurement of the pattern cross-section, the GUI is also able to do setting of the height 9007. In this case, as explained in relation to FIG. 6, the height at which dimension measurement is conducted can be set by a certain percentage between the maximum height and the minimum height of the pattern, or by an actual height (nm) with either the minimum value of the pattern height or the maximum value to be used as the base line (if the minimum value of the pattern height is adopted as the base line, actual length is set up in the upward direction; if the maximum value is adopted as the base line, actual length is set up in the downward direction). The established cross-section measurement position can be displayed by overlay 9008 in the AFM measurement data area 9004 shown in the pattern shape data display area 9003.

If it so happens upon checking (715) that no data stored in the database matches with the result of the AFM measurement of side wall shape of the object pattern, the display area 9009 is to carry the announcement of “No matching data in database.”

As described above, it has become possible to provide users with the dimensions of the patterns after correction of dimension measuring errors between the CD-SEM measurement and the AFM measurement, and the information on the patterns of the measurement object.

[GUI for Compiling Database]

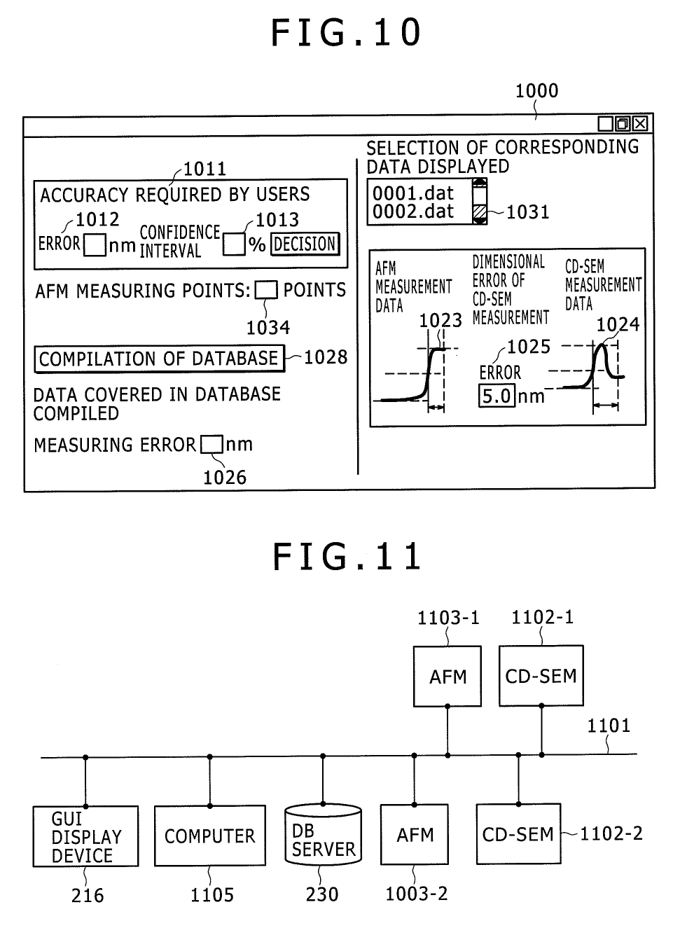

FIG. 10 is a drawing explaining about an example of GUI display 1000 used at the time of compilation of database 109 relating to the preferred embodiments of the present invention. This GUI displays the number of AFM measuring points necessary to satisfy the accuracy required by the user on the basis of the assumed dimensional errors computed from the CD-SEM signal waveform and the side wall shape data, both being homologized with each other in the above. Referring to the above number of AFM measuring points, the user performs cross-sectional measurement. After the AFM measurement, the user is able to indicate the assumed dimensional errors computed from the CD-SEM signal waveform and the side wall shape data.

The above GUI 1000 has the user's requiring accuracy input area 1011 where to input the dimension measurement accuracy 1012 required by the user as explained in relation to FIG. 5 and the confidence interval 1013. Based on these inputs the number of AFM measuring points is to be worked out as explained in relation to FIG. 5, and the computational result is to be indicated in the AFM measuring points display area 1034. The user is required to refer to the AFM measuring points displayed to carry out AFM measurement.

After AFM measurement, click the “create” database button 1028, and the CPU 221 of the processing and controlling unit 215 will start making of database 109 in which the AFM measurement data and the dimension measuring errors of the CD-SEM measurement are homologized with each other, and the database 109 will renew the old database file 109 in the database server 230. Further, the renewed database 109 can be used to perform dimension measurement and present estimated errors 1026. Also, it is possible to display AFM measurement data 1023 which is homologized and stored in the database 109, and to display the dimension measuring error 1025 of the corresponding CD-SEM measurement.

The CD-SEM signal waveform used when the corresponding data was compiled, is to be kept in storage when making the database, while being homologized with the AFM measurement. This CD-SEM signal waveform can be displayed 1024 any time.

Any corresponding data, if necessary, can be displayed in image or by selection from the list of data ID list 1031. In summary, by using the above GUI, it has now become possible that the AFM measurement data covering patterns and the dimension measuring errors of CD-SEM measurement data covering the same patterns are homologized with each other and stored in the database 109

[Configuration Device Network]

FIG. 11 is an explanatory drawing showing an example of configuration of network of various devices. Each device is configured to be connected to the network 1101. The present invention is realized by CD-SEM 1102-1 and 1102-2, AFM 1103-1 and 1103-2, database server 230, computer 1105, and GUI display device, all connected by the network 1101 so as to enable through-the-network communications of CD-SEM measurement data, AFM measurement data, database checking result, computational result of dimension measuring errors from CD-SEM measurement and AFM measurement, and correctional result data of CD-SEM measuring errors. The computer 1105 takes care of arithmetic processing, such as computational processing of number of AFM measuring points, database checking processing, dimension measuring errors computing processing, and measuring errors correctional processing. The processing and controlling unit 215 explained in FIG. 2A may as well be configured as an integral part of the computer 1105. Also, The GUI display device is intended to display GUI as shown in FIGS. 9 and 10. The device configuration as viewed above has made it possible to do processing of the present invention through the intermediary of network.

[Processing Flow for Computation of Measuring Accuracy]

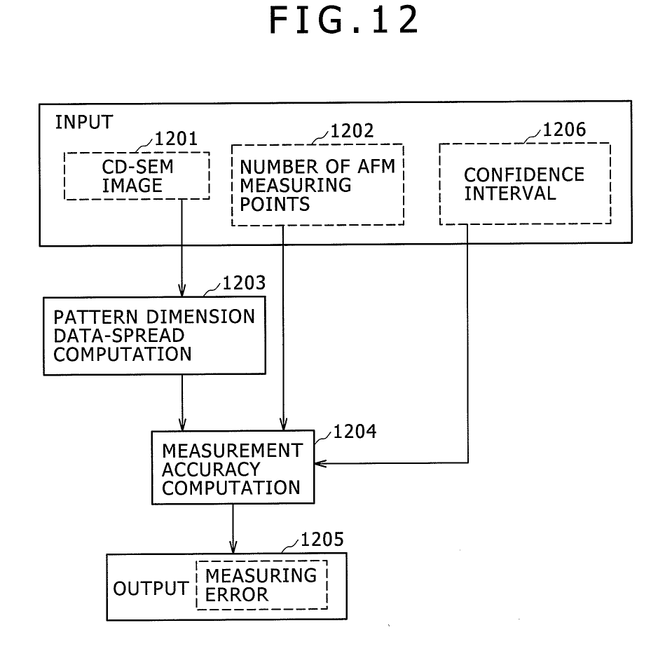

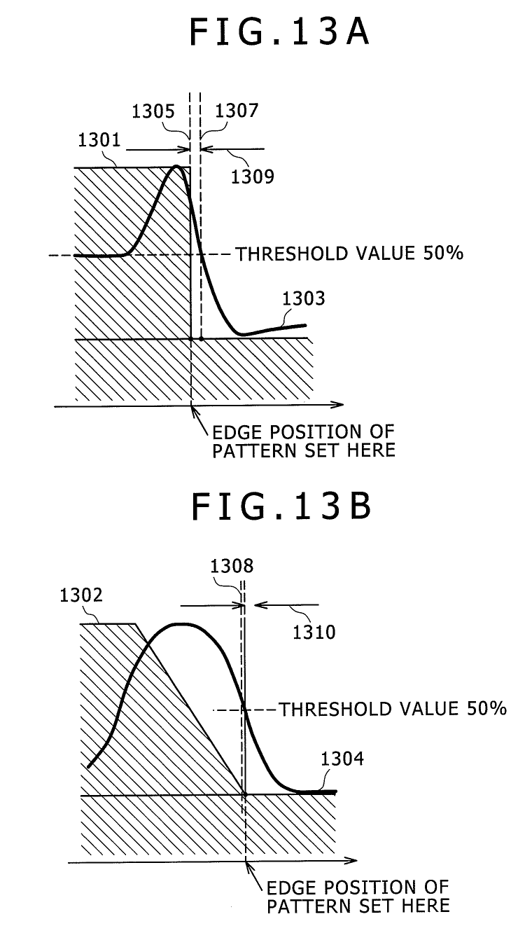

FIG. 12 is a drawing to explain about various processing flows relating to preferred embodiments of the present invention, such as the processing flow to output, dimension measuring errors of CD-SEM measurement 1205, which are estimated from the number of measuring points 1202 of AFM measurement data stored in the database 109, for correction of pattern dimensional values; or the processing flow to output the same dimension measuring errors 1025.

Sources of input to the above processing are the CD-SEM images 1201 covering the patterns used for database compilation, AFM measuring points 1202 covering the same patterns, and the confidence interval 1206 (95%, for example) of dimension measuring errors computed in the subject processing.

Output source is the above dimension measuring errors 1205. From the CD-SEM images 1201, dimensional dispersion of patterns is to be computed 1203 by the method explained in FIG. 4

Dimension measuring errors are computed 1204 by the estimated error computing method explained in FIG. 5 from the pattern dimension dispersion computed above, the number of AFM measuring points 1202, and the confidence interval 1206. The computed errors are presented by GUI, etc., to the users 1205.

An example of the above GUI display can be found in FIG. 10. The CD-SEM measurement data is read-in 1030, and AFM measurement data is also read-in 1031. Estimated error is computed depending on the read-in data and displayed 1026 (confidence interval 1013 is inputted by the user). Displaying method is not limited to what is described above, but any GUI is permissible if processing is performed to the same effect.

With the above-mentioned processing done properly, the user is able to confirm the estimated errors that would be likely to happen when the measurement data stored in the database were used, and therefore, the user would be able to evaluate the estimated result of dimension measurement, taking into consideration the above-mentioned errors that would be contained in the estimate.

The invention may be embodied in other specific forms without departing from the spirit or essential characteristics thereof. The present embodiment is therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A scanning electron microscope, comprising:
a scanning electron microscope(SEM) means for taking images of measurement object patterns formed on specimens and acquiring SEM images of said measurement object patterns;
an image processing means for processing said SEM images of said measurement object patterns acquired by said scanning electron microscope and obtaining dimensional information of said measurement object patterns;
a dimensional error information extraction means for extracting the dimensional error information corresponding to said measurement object patterns out of the information including the shape information of the patterns measured by some other measuring means and the dimensional error information of the SEM images of the same patterns, which were preliminarily stored in a separate storage device;
a pattern dimensional information correction means for correcting the dimensional information of said measurement object patterns that was obtained after processing by said image processing means, by using said dimensional error information corresponding to said measurement object patterns extracted by said dimensional error information extraction means; and
an output means for outputting onto a display screen such dimensional information of said measurement object patterns that was corrected by said pattern dimensional information correction means.

2. The scanning electron microscope according to claim 1, wherein, said dimensional error information extraction means, out of the pattern SEM images and the pattern dimension error information, the former being homologized with the shape information obtained by measurement with an atomic force microscope (AFM) and preliminarily stored in a separate storage device and the latter being computed from the pattern SEM images, extracts the pattern dimension error information computed from the SEM images of said measurement object patterns utilizing the information available from measurement of said measurement object patterns by an atomic force microscope

3. The scanning electron microscope according to claim 2, wherein, upon processing of SEM images of said measurement object patterns by said image processing means, dimensional dispersion is to be checked at plural number of points of said measurement object patterns, and to find out necessary number of measuring points based on the obtained information on such dimensional dispersion and to carry out measurement of said measurement object patterns by said atomic force microscope, a number of measuring points computation means should be additionally provided; and
said output means is to display on said display screen the information concerning the number of measuring points where said number of measuring points computation means has computed said measurement by said atomic force microscope be carried out.

4. The scanning electron microscope according to claim 2, wherein,
said output means displays, along with the dimensional information of said measurement object patterns as corrected by said pattern dimensional information correction means, the SEM images of said measurement object patterns and the points where measurement was made by said atomic force microscope.

5. The scanning electron microscope according to claim 2, wherein,
said output means displays, along with the dimensional information of said measurement object patterns as corrected by said pattern dimensional information correction means, the SEM image signals of said measurement object patterns and the shape information of said measurement object patterns obtained by measurement of said atomic force microscope.

6. Pattern dimension measuring method, comprising the steps of:
taking images of measurement object patterns formed on a specimen by means of a scanning electron microscope acquiring SEM images of said measurement object patterns;
processing said SEM images of said measurement object patterns acquired as above thus acquiring the dimensional information of said measurement object patterns;
extracting dimensional error information corresponding to said measurement object patterns out of the information including shape information kept in storage in advance and of the pattern measured by a method other than said scanning electron microscope and the other information including dimensional error information measured from the SEM images of the same patterns;
correcting the dimensional information of said measurement object patterns by using the dimensional error information corresponding to the same extracted measurement object patterns; and
outputting the same corrected dimensional information of the measurement object patterns onto the display screen.

7. The pattern dimension measuring method according to claim 6, wherein:
in the process of extracting said dimensional error information, said information kept in storage in advance comprises the shape information available from measurement by an atomic force microscope, the SEM images of the patterns kept in storage homologized with the same shape information, and error information of the pattern dimension computed from the SEM images of the same pattern; the process of extracting said dimensional error information is the process of extracting error information of the pattern dimension computed from the SEM images of the same pattern, by using the shape information available from measurement by an atomic force microscope, out of the information in storage in advance.

8. The pattern dimension measuring method according to claim 7, wherein: it is further included that dimensional data-spread is obtained in plural points in said measurement object pattern available from processing of the SEM images, and that based on the information concerning dimensional data-spread, the dimension of said measurement object pattern and therefore the number of measuring points for measurement by said atomic force microscope need be computed, and result of computation also need be shown on the display.

9. The pattern dimension measuring method according to claim 7, wherein:
in the process of outputting to the display, it is necessary to indicate corrected dimensional information of the measurement object pattern and at the same time to display the points where measurement was carried out on the SEM images of said measurement object pattern and on said measurement object pattern itself by said atomic force microscope.

10. The pattern dimension measuring method according to claim 7, wherein:
in the process of outputting to the display, it is necessary to indicate, along with said corrected dimensional information of said measurement object pattern, the SEM image signal of said measurement object pattern and the shape information of said measurement object pattern obtained by measurement by said atomic force microscope.

11. Pattern dimension measuring method, comprising the steps of:
taking images of measurement object patterns formed on a specimen by means of a scanning electron microscope acquiring SEM images of said measurement object patterns, and acquiring also dimensional information from said SEM images;
measuring said measurement object pattern by an atomic force microscope acquiring shape information of said measurement object patterns;
extracting dimensional error information corresponding to said measurement object patterns out of the information including shape information kept in storage in advance and of the pattern measured by an atomic force microscope and the other information including dimensional error information measured from the SEM images of the same patterns;
correcting the dimensional information of said measurement object patterns by using the dimensional error information corresponding to the same extracted measurement object patterns; and
outputting the same corrected dimensional information of the measurement object patterns onto the display screen.

12. Pattern dimension measuring method according to claim 11, wherein:
it is further included that dimensional data-spread is obtained in plural points in said measurement object pattern available from processing of the SEM images, and that based on the information concerning dimensional data-spread, the dimension of said measurement object pattern and therefore the number of measuring points for measurement by said atomic force microscope need be computed, and result of computation also need be shown on the display.

13. Pattern dimension measuring method according to claim 11, wherein,
said process of outputting onto the display screen, said corrected dimensional information of said measurement object pattern is to be indicated, and at the same time, the points of SEM images of said measurement object patterns or measurement object patterns where measurement by said atomic force microscope was made would be shown.

14. Pattern dimension measuring method according to claim 11, wherein,
in the process of outputting onto the display screen, said corrected dimensional information of measurement object patterns will be displayed together with the SEM image signal and the shape information of said measurement object patterns which were obtained by virtue of said atomic force microscope.
